(19) United States
(12) Patent Application Publication
(10) Pub. No.: US 2012/0327235 A1
(43) Pub. Date: Dec. 27, 2012

(54) VIDEO SIGNAL PROCESSING SYSTEM

(75) Inventors: Masaaki Wada, Kumagaya-shi (JP); Toru Okada, Ota-shi (JP); Kazunori Chida, Gunma-ken (JP); Hiroki Ishida, Isesaki-shi (JP)

(73) Assignee: SEMICONDUCTOR COMPONENTS INDUSTRIES, LLC, Phoenix, AZ (US)

(21) Appl. No.: 13/530,173

(22) Filed: Jun. 22, 2012

(30) Foreign Application Priority Data
Jun. 24, 2011 (JP) 2011-140804

(51) Int. Cl. H04N 7/18

(52) U.S. Cl. 348/148; 348/143; 348/E07.085

(57) ABSTRACT

Video from a backup camera (10) is displayed early on an LCD panel (16). During startup of a system, a display controller (14) performs settings according to preset data from a memory (20), a video signal directly supplied from the backup camera (10) is selected by a selector (54), subjected to resolution conversion and supplied to an LCD panel (16). On the other hand, after the system controller (12) has been started up, a video signal supplied from the system controller (12) is selected by the selector (54) and supplied to the LCD panel (16).

### CROSS-REFERENCE TO RELATED APPLICATION(S)

The entire disclosure of Japanese Patent Application No. 2011-140804 filed on Jun. 24, 2011, including specification, claims, drawings, and abstract, is incorporated herein by reference in its entirety.

### BACKGROUND

1. Technical Field

The present invention relates to a video signal processing system including a system controller and a display controller.

2. Background Art

Heretofore, a vehicle often has mounted a monitor, such as a map display of a navigation device. Furthermore, a vehicle is often equipped with a backup camera for confirming the rear of the vehicle, in which case a monitor for the driver becomes essential.

Furthermore, regulations in the United States require new vehicles from the year 2014 to be equipped with a backup camera. Also, the backup camera is required to instantly display a backup camera video on a monitor when the engine is started. Liquid crystal displays are often utilized for the monitor.
Patent document 1: Japanese Patent Laid-Open Publication No. 2010-109684

### SUMMARY OF THE INVENTION

Here, as the video displayed on the monitor is required to preferably be easy to view, various settings are applied and video processing is performed causing the time until startup to be long.

The present invention is a video signal processing system including a system controller and a display controller, wherein the system controller includes a first video signal processing circuit for decoding regarding a video signal from a camera and obtaining a first video signal and a processing section connected to an external bus, therefrom supplied preset data is utilized for controlling processing at the first video signal processing circuit, and the display controller includes a second video signal processing circuit for decoding regarding the video signal from the camera and obtaining a second video signal, a selector for selecting either the first video signal or the second video signal, an interface for outputting an output of the selector toward a display panel, and a setting section connected to the external bus, therefrom supplied preset data is used for performing various settings, wherein at system startup the display controller performs setting using preset data from a memory section, selects the second video signal by the selector, converts the resolution of the second video signal and outputs a video signal, and after the system controller has started up, the first video signal is selected by the selector and the first video signal is supplied to the display.

During system startup, startup can be speeded up since the display controller directly processes the video signal from the camera without using the system controller.

### BRIEF DESCRIPTION OF THE DRAWINGS

FIG. 1 is a block diagram showing a configuration of an embodiment.

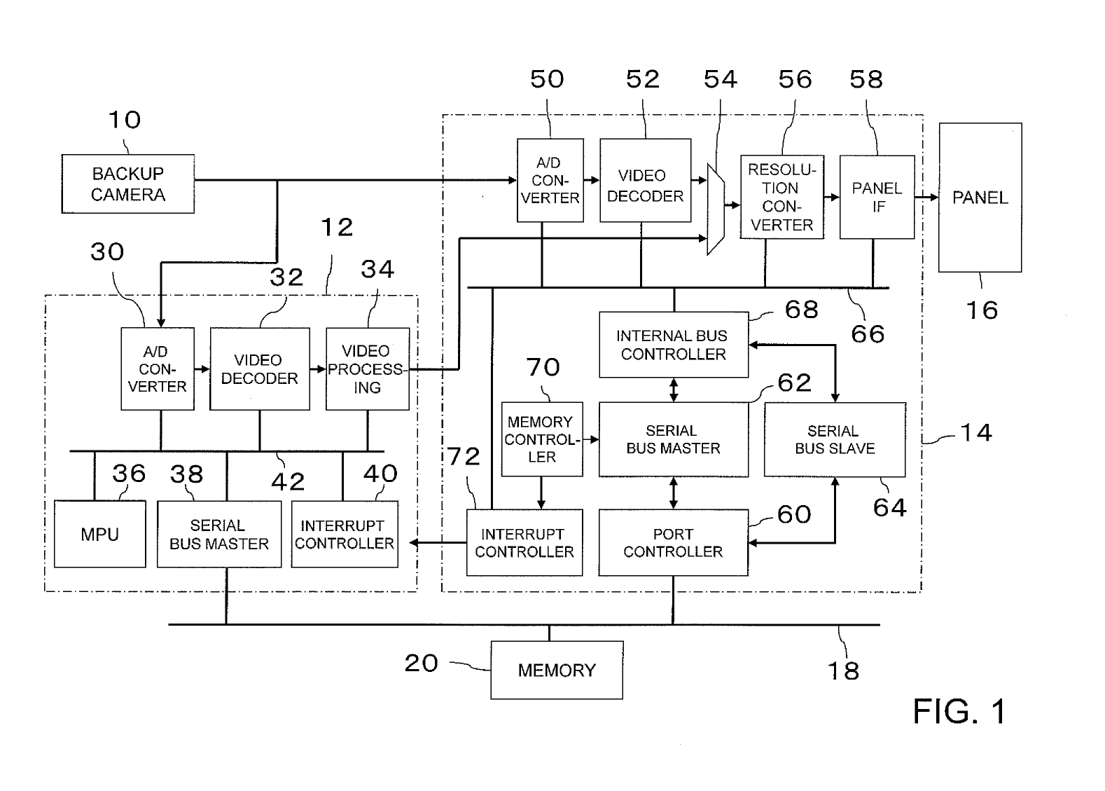

FIG. 2 is a flowchart showing an operation at startup of an LCD controller.

### DETAILED DESCRIPTION

Embodiments of the present invention will be described hereinafter with reference to the attached drawings.

A backup camera 10 is installed facing the rear on a vehicle and acquires a video of the rear of the vehicle. Various types of devices, such as CCD cameras, for outputting an electric signal (video signal) for video can be utilized as the backup camera 10.

To the backup camera 10 is connected a system controller 12 to which a video signal from the backup camera 10 is supplied and where conversion to a digital signal and various video processing operations are performed. An output of the system controller 12 is supplied to an LCD controller (display controller) 14 where conversion is performed into a signal for display on an LCD panel 16, the output signal is supplied to the LCD panel 16, and the video acquired by the backup camera 10 is displayed on the LCD panel 16. Although a liquid crystal (LCD) panel is used in the embodiment, another type of display, such as an organic EL panel, may be used.

Furthermore, to the system controller 12 and the LCD controller 14 is connected an external serial bus 18 and data can be exchanged via the serial bus 18. In particular, in this embodiment a nonvolatile memory (EEPROM) 20 is connected to the serial bus 18 and various types of preset data registered in the EEPROM 20 are read by the system controller 12 and the LCD controller 14 and utilized to process the video signal.

Here, a configuration of the system controller 12 will be described. The video signal supplied from the backup camera 10 is supplied to an A/D converter 30 where conversion to digital data is performed. The digital video signal, which was converted from analog to digital, is supplied to a video decoder 32 and decoded and separated for every pixel into video data and a synchronization signal. The decoded video data is supplied to a video processing circuit 34 where desired image processing is performed, such as white balance, adjustment regarding brightness, gamma conversion, edge enhancement, and noise removal.

Furthermore, the system controller 12 is provided with an MPG 36, a serial bus master 38, and an interrupt controller 40, which are connected in common with the above-mentioned A/D converter 30, the video decoder 32, and the video processing circuit 34 by an internal bus 42. Moreover, the serial bus 18 is connected to the serial bus master 38.

The MPU 36 performs data processing necessary for the overall processing of the system controller 12 and performs overall control. The serial bus master 38 controls the serial bus 18 and controls a serial bus slave of the LCD controller to be described hereinafter. The interrupt controller 40 processes interrupt requests from the LCD controller 14.

The LCD controller 14 has an A/D converter 50 and a video decoder 52 and accepts the video signal from the backup camera 10 and obtains decoded video data of every pixel. The decoded video data is supplied to a switching gate 54. Video-processed video data from the video processing circuit 34 of the system controller 12 is also supplied to the switching gate 54. The switching gate 54 has been set to adopt data from the video decoder 52 during startup and depending on a control signal from the system controller 12 switches to adopt data from the system controller 12.

An output of the switching gate 54 is supplied to a resolution conversion circuit 56 where resolution conversion is performed, such as to conform to the size of the LCD panel 16. An output of the resolution conversion circuit 56 is supplied to the LCD panel 16 via a panel IF (interface) 58 and a video acquired by the backup camera 10 is displayed on the LCD panel 16.

Furthermore, the LCD controller 14 is provided with a port controller 60, which is connected to the serial bus 18, and to the port controller 60 are connected a serial bus master 62 and a serial bus slave 64. Moreover, an internal bus controller 68, which is connected to an internal bus 66, is connected to the serial bus master 62 and the serial bus slave 64. Still further, a memory controller 70 is connected to the serial bus master 62 and an interrupt controller 72 is connected to the memory controller 70. The interrupt controller 72 supplies an interrupt control signal to the interrupt controller 40 of the system controller 12.

The port controller 60 selects the serial bus master 62 during startup and the serial bus master 62 performs communication by controlling the serial bus 18. In this case, the memory controller 70 controls the serial bus master 62, reads specific preset data stored in the memory 20, and supplies the data to the resolution conversion circuit 56 and so forth of the LCD controller 14 via the internal bus controller 68 and the internal bus 66. Furthermore, when the system controller 12 is started, the system controller 12 controls the port controller 60 to select the serial bus slave 64. Then, from the serial bus master 38 via the serial bus 18, preset data which was set within the system controller 12 is set into various parts within the LCD controller 14 by the serial bus slave 64.

Furthermore, when the memory controller 70 completes the various settings in the LCD controller 14 and the video display on the LCD panel 16 begins, the interrupt control signal is supplied to the system controller 12.

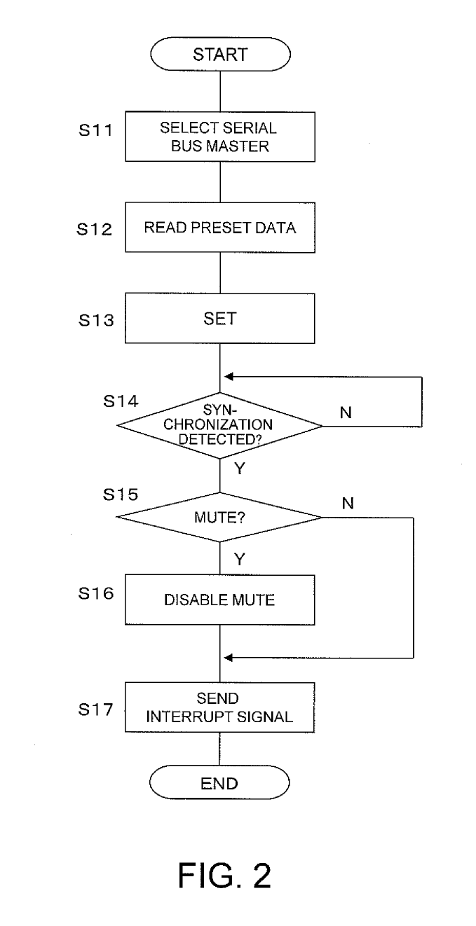

Here, the processing flow at the LCD controller 14 will be described with reference to FIG. 2. First, during startup of the system with the power on and the reset processing completed, the serial bus master 62 is selected (S11). Then, in accordance with a signal from the memory controller 70 the serial bus master 62 accesses the memory 20 via the serial bus 18 and reads necessary preset data (S12). Then, the read preset data is set into various parts within the LCD controller 14 via the internal bus controller 68 and the internal bus 66 (S13).

As described hereinabove, the switching gate 54 is set to automatically select data from the video decoder 52 at startup. However, the selection of the switching gate 54 may be set when setting the various parts via the internal bus 66.

Here, when the setting of S13 completes, a clock is supplied to each circuit and each circuit enters an operating state. However, whether the backup camera 10 is stable in a state for outputting a stable video signal is unknown. Accordingly, at this time, a MUTE video (such as an entire black screen video) signal generated at the panel IF 58 is output.

At the video decoder 52, it is determined whether a synchronization signal was able to be detected (S14). If the synchronization signal is detected, it is determined the video signal output from the backup camera 10 is stable and the next process (S15) is performed. Next, the level of a MUTE flag, which the LCD controller 14 inputs, is detected, and it is determined whether to disable the MUTE video and output the video of the backup camera 10 or continue to output the MUTE video (S15). It is supposed this MUTE flag is a signal linked to control of a reverse gear. For example, if the reverse gear is not selected (shift position is not in reverse) when the engine is started, the MUTE flag is set to “0”. At this time, the LCD controller 14 does not output the video from the backup camera 10 and the MUTE video generated by the panel IF 58 is output from the LCD controller 14. Then, after startup of the system controller 12, a main video signal from the video processing circuit 34 of the system controller 12 is output from the LCD controller 12 and displayed on the panel 16. On the other hand, if the reverse gear is selected (shift position is in reverse) when the engine is started, the MUTE flag is set to “1”. In this case, the LCD controller 12 disables the MUTE video and outputs the video of the backup camera 10. As a result, even when the reverse gear is selected at the same time the engine is started, it becomes possible to output the video of the backup camera 10 to the LCD panel 16 without waiting for the startup of the system controller 12. When the above-mentioned processing completes, an interrupt signal is supplied to the system controller 12 from the interrupt controller 72 (S17).

On the other hand, the system controller 12 performs various settings during startup and when the startup process completes and a predetermined video signal from the video processing circuit 34 begins to be output, the interrupt controller 40 determines whether an interrupt signal is being supplied from the LCD controller 14.

Then, if the interrupt signal is being supplied, it is known the LCD controller 14 is operating normally so that a signal is sent to the LCD controller 14, the switching gate 54 is switched, and the video signal from the video processing circuit 34 of the system controller 12 is selected. Therefore, the video signal from the video processing circuit 34 of the system controller 12 is supplied thereafter to the LCD panel 16.

In this manner, during startup of the system, the system relating to the embodiment accepts an analog composite signal from the backup camera 10 at the LCD controller 14 and the corresponding video thereof can be displayed on the LCD panel 16. Therefore, when an ignition switch is turned on, a video of the backup camera 10 can be immediately displayed on the LCD panel 16.

Then, the port controller 60 switches the connection to the serial bus 18 to the serial bus slave 64 in accordance with a control signal from the system controller 12. Therefore, the video thereafter subjected to image processing at the video processing circuit 34 in the system controller 12 can be displayed on the LCD panel 16.

While there has been described what are at present considered to be preferred embodiments of the invention, it will be understood that various modifications may be made thereto, and it is intended that the appended claims cover all such modifications as fall within the true spirit and scope of the invention.

What is claimed is:

1. A video signal processing system comprising a system controller and a display controller, said system controller comprises:
a first video signal processing circuit for decoding regarding a video signal from a camera and obtaining a first video signal; and
a processing section connected to an external bus, therefrom supplied preset data is utilized for controlling processing at said first video signal processing circuit;
and said display controller comprises:
a second video signal processing circuit for decoding regarding the video signal from the camera and obtaining a second video signal;
a selector for selecting either said first video signal or said second video signal;
an interface for outputting an output of the selector toward a display panel; and
a setting section connected to said external bus, therefrom supplied preset data is used for performing various settings; wherein at system startup
said display controller performs setting using preset data from a memory section, selects the second video signal by the selector, converts the resolution of the second video signal and outputs a video signal,
and after the system controller has started up, the first video signal is selected by the selector and the first video signal is supplied to said display.

2. A video signal processing system according to claim 1, wherein said video signal processing system is mounted in a vehicle and the video signal obtained from the camera is a video signal regarding the rear of the vehicle.

3. A video signal processing system according to claim 2, wherein said selector automatically selects the second video signal at system startup.

4. A video signal processing system according to claim 3, wherein at system startup when a shift position is in reverse, said display controller supplies the second video signal to said display, and when the shift position is not in reverse, said display controller supplies a mute video signal to said display.
